(19) United States
(12) Patent Application Publication
(10) Pub. No.: US 2023/0049023 A1
(43) Pub. Date: Feb. 16, 2023

(54) LOW ODOUR CYANOACRYLATE COMPOSITION

(71) Applicant: Henkel AG & Co. KGaA, Duesseldorf (DE)

(72) Inventors: Zuohe Zuohe Wang, Shanghai (CN); Chongjian Zuohe Song, Shanghai (CN); Chongyang Sun, Shanghai (CN); Heqiang Zhang, Shanghai (CN)

(21) Appl. No.: 17/961,722

(22) Filed: Oct. 7, 2022

Related U.S. Application Data
(63) Continuation of application No. PCT/CN2020/083469, filed on Apr. 7, 2020.

(51) Int. Cl. C08F 22/32; C08L 23/08; C09J 4/06

(52) U.S. Cl. CPC C08F 22/32; C08L 23/0869; C09J 4/06

(57) ABSTRACT

This invention relates to a cyanoacrylate composition comprising at least one rubber toughening compound; and at least one β-alkoxyalkyl cyanoacrylate. The rubber toughening compound and β-alkoxyalky cyanoacrylate are well compatible with each other so that high odor alkyl cyanoacrylates, such as ethyl cyanoacrylate, is not needed in the composition. The cured product of cyanoacrylate composition exhibits excellent side impact and T-peel strength to various of metals.

### TECHNICAL FIELD

This invention relates to a cyanoacrylate composition comprising at least one rubber toughening compound; and at least one β-alkoxyalkyl cyanoacrylate. The rubber toughening compound and β-alkoxyalky cyanoacrylate are well compatible with each other so that high odor alkyl cyanoacrylates, such as ethyl cyanoacrylate, is not needed in the composition. The cured product of cyanoacrylate composition exhibits excellent side impact and T-peel strength to various materials, such as metals, plastics and woods.

### BACKGROUND OF THE INVENTION

Cyanoacrylate adhesive is well known for its instant bonding property and has been widely used in many different fields. Traditional cyanoacrylate adhesive has the drawback that its cured product does not show good impact resistance, and therefore needs to be reinforced with a rubber toughening compound. Alkyl cyanoacrylate monomer, such as ethyl cyanoacrylate, has demonstrated to be well compatible with the rubber toughening compound to make a toughened cyanoacrylate adhesive composition. However, ethyl cyanoacrylate has a strong odor which makes the cyanoacrylate adhesive composition unpleasant to be used. Furthermore, ethyl cyanoacrylate often causes blooming of the cured cyanoacrylate adhesive, and therefore not suitable to be used if the aesthetic appearance of an article bonded by the cyanoacrylate adhesive is important.

Therefore, there is a need for developing a low odor cyanoacrylate composition which has good side impact and/or T-peel strength.

### SUMMARY OF THE INVENTION

The present invention relates to a cyanoacrylate composition, comprising:

(a) at least one rubber toughening compound; and

(b) at least one β-alkoxyalkyl cyanoacrylate represented by structure (I):

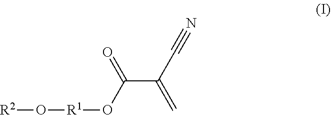

wherein
R¹ represents a C₁-C₈ optionally substituted divalent hydrocarbon group, preferably a C₁-C₄ optionally substituted divalent hydrocarbon group, and more preferably a C₂-C₃ optionally substituted divalent hydrocarbon group; and
R² represents a C₂-C₂₀ optionally substituted univalent hydrocarbon group, preferably a C₂-C₈ optionally substituted univalent hydrocarbon group, and more preferably a C₂-C₄ optionally substituted univalent hydrocarbon group.

The present invention also relates to a cured product of the cyanoacrylate composition. The cured product of the cyanoacrylate composition exhibits excellent side impact and T-peel strength to various materials, such as metals, plastics and woods.

The present invention also relates to an article bonded by the cyanoacrylate composition.

The present invention also relates to a process of preparing the cyanoacrylate composition, comprising steps of:

a) mixing all components together at a temperature from 50 to 80° C. to dissolve the rubber toughening compound completely to obtain a clear solution; and

b) cooling the solution from step a) to room temperature.

The present invention also relates to a method of bonding two substrates together, comprising the steps of:

a) applying a cyanoacrylate composition to at least one of the substrates; and

b) mating the substrates together for a sufficient time to permit the composition to fixture.

### BRIEF DESCRIPTION OF THE FIGURES

FIG. 1 illustrates the blooming of the cured products of the cyanoacrylate compositions in Ex.1, Ex.2 and Ex.6; and

FIG. 2 illustrates the solubility of rubber toughening compound in different cyanoacrylate monomers in Ex.3 and Ex.7.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or process steps.

The recitation of numerical end points includes all numbers and fractions subsumed within the respective ranges, as well as the recited end points.

All references cited in the present specification are hereby incorporated by reference in their entirety.

Unless otherwise defined, all terms used in the disclosing the invention, including technical and scientific terms, have the meaning as commonly understood by one of the ordinary skills in the art to which this invention belongs to. By means of further guidance, term definitions are included to better appreciate the teaching of the present invention.

In the context of this disclosure, a number of terms shall be utilized.

The term “(meth)acrylate” refers to both or any one of “acrylate” and “methacrylate”.

The term “(meth)acrylic” refers to both or any one of “acrylic” and “methacrylic”.

The term “monomer” refers to a polymer building block which has a defined molecular structure, and which can be reacted to form a part of a polymer.

The term “hydrocarbon group” refers to an organic group consisting of carbon and hydrogen. Example of hydrocarbon group includes but limited to an alkyl group, such as methyl, ethyl, propyl, butyl, pentyl, hexyl, isopropyl, tertiary butyl, isobutyl and the groups alike; an alkenyl group, such as vinyl, allyl, butenyl, pentenyl, hexenyl and the groups alike; an aralkyl group, such as benzyl, phenethyl, 2-(2,4,6-trimethylphenyl)propyl and the groups alike; an aryl group, such as phenyl, tolyl, xyxyl and the groups alike; or an alkylidene group, such as methylidene, ethylidene, propylidene and the groups alike.

The term “optionally substituted” in the term of “optionally substituted hydrocarbon group” means that one or more hydrogens on the hydrocarbon group may be replaced with a corresponding number of substituents preferably selected from halogen, nitro, azido, amino, carbonyl, ester, cyano, sulfide, sulfate, sulfoxide, sulfone, sulfone groups, and the likes.

The term “substantially free” means that a material or functional group can be present in an incidental amount or that a particular occurrence or reaction only takes place to an insignificant extent, which does not affect desired properties. In other words, the material or functional group is not intentionally added to an indicated composition, but may be present at minor or inconsequential levels, for example, because it was carried over as an impurity as part of an intended composition component.

### Rubber Toughening Compound

The cyanoacrylate composition of the present invention comprises at least one rubber toughening compound. The rubber toughening compound is selected from the group consisting of (a) reaction products of the combination of ethylene, methyl acrylate and monomers having carboxylic acid cure sites, (b) copolymers of ethylene and methyl acrylate, (c) vinylidene chloride-acrylonitrile copolymers, (d) vinyl chloride/vinyl acetate copolymer, (e) copolymers of polyethylene and polyvinyl acetate, and combinations thereof.

In some embodiments of the present invention, the rubber toughening compound is preferably a reaction product of the combination of ethylene, methyl acrylate and monomers having carboxylic acid cure sites, wherein the reaction product is substantially free of processing aids, such as release agent, complex organic phosphate esters, stearic acid and polyethylene glycol ether wax; and anti-oxidants, such as substituted diphenyl amine.

Examples of commercially available rubber toughening compound are, for example, VAMAC VCS 5500, VAMAC MR, VAMAC G, VAMAC N123, VAMAC B-124, VAMAC VMX 1012 and VCD 6200 from DuPont.

In some embodiments of the present invention, the amount of the rubber toughening compound is preferably from 1 to 50%, and more preferably from 1 to 30% by weight based on the total weight of the cyanoacrylate composition.

### β-Alkoxvalkyl Cyanoacrylate

The cyanoacrylate composition of the present invention comprises at least one (β-alkoxyalkyl cyanoacrylate represented by structure (I):

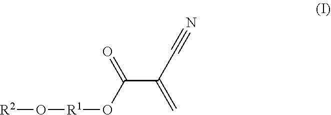

wherein
R¹ represents a C₁-C₈ optionally substituted divalent hydrocarbon group, preferably a C₁-C₄ optionally substituted divalent hydrocarbon group, and more preferably a C₂-C₃ optionally substituted divalent hydrocarbon group; and
R² represents a C₂-C₂₀ optionally substituted univalent hydrocarbon group, preferably a C₂-C₈ optionally substituted univalent hydrocarbon group, and more preferably a C₂-C₄ optionally substituted univalent hydrocarbon group.

The β-alkoxyalkyl cyanoacrylate of structure (I) may be synthesized as suggested in the paper “Synthesis and Characterization of Ethoxyethyl α-Cyanoacrylate and Reaction Intermediates” (Journal of Applied Polymer Science, Vol. 87, 1758-1773 (2003) by generating an oligo(β-alkoxyalkyl cyanoacrylate) first through reacting alkoxyalkyl cyanoacetate with paraformaldehyde, followed by depolymerization at an elevated temperature in an acidic atmosphere with a high vacuum.

Illustrative examples of β-alkoxyalkyl cyanoacrylate of structure (I) include but are not limited to β-ethoxyethyl cyanoacrylate, β-propoxyethyl cyanoacrylate, β-butoxyethyl cyanoacrylate, β-isopropoxyethyl cyanoacrylate, β-ethoxypropyl cyanoacrylate, and β-ethoxybutyl cyanoacrylate. Preferably, the β-alkoxyalkyl cyanoacrylate in the present invention is β-ethoxyethyl cyanoacrylate.

In some embodiments of the present invention, the weight ratio between the β-alkoxyalkyl cyanoacrylate and the rubber toughening compound is preferably from 100:0.5 to 100:50, more preferably from 100:3 to 100:30, and even more preferably from 100:10 to 100:30. Within the desirable weight ratio, not only the β-alkoxyalkyl cyanoacrylate and the rubber toughening compound are well compatible, the cured product of the cyanoacrylate composition would also has improved side impact and/or T-peel strength to various materials, such as metals, plastics and woods.

Examples of commercially available β-alkoxyalkyl cyanoacrylate, for example, are AFINITICA 2-Ethoxyethyl Cyanoacrylate from Afinitica Technologies S.L.; and 2-ethoxyethyl 2-cyanoacrylate from Cartell Chemical Co., Ltd.

In some embodiments of the present invention, the amount of the β-alkoxyalkyl cyanoacrylate is preferably from 50% to 99%, and more preferably from 70 to 99% by weight based on the total weight of the cyanoacrylate composition.

### Optional Additives

The cyanoacrylate composition may further comprise optional additives. The selection of suitable additives for the cyanoacrylate composition of the invention depends on the specific intended use of the cyanoacrylate composition and can be determined in the individual case by those skilled in the art.

### Acid Stabilizer

The cyanoacrylate composition of the present invention may further comprise at least one acid stabilizer. The acid stabilizer may be selected from the group consisting of boron trifluoride, boron trifluoride etherate complex, boron trifluoride dihydrate, trimethylsilyl triflate, sulphur dioxide, methanesulfonic acid, and mixtures thereof.

Examples of commercially available acid stabilizer are, for example, boron trifluoride diethyl etherate and boron trifluoride dihydrate from Sigma-Aldrich.

In some embodiments of the present invention, the amount of the acid stabilizer is preferably from 0 to 100 ppm, and more preferably from 0 to 30 ppm by weight based on the total weight of the cyanoacrylate composition.

### Carboxylic Acid

The cyanoacrylate composition of the present invention comprises at least one carboxylic acid to improve the shock resistance and/or T-peel strength of the cured product of the cyanoacrylate composition. The carboxylic acid may be selected from the group consisting of citric acid and its monohydrate, 1,2,4-benzene tricarboxylic acid (or trimellitic acid), hemimellitic acid, trimesic acid, pyromellitic acid, 1,2,3,4-butane tetracarboxylic acid, glutaric acid, 1,2,4,5-benzene tetracarboxylic acid, 1,2,4-benzene tricarboxylic anhydride, 1,2,3-propene tricarboxylic acid (or aconitic acid), 1,2,3-propane tricarboxylic acid (tricarballylic acid), 1,2,3-benzene tricarboxylic acid hydrate and combinations thereof. Preferably, the carboxylic acid is citric acid.

Examples of commercially available a carboxylic acid are, for example, trimellitic acid from Tokyo Chemical Industry; and citric acid from Sigma-Aldrich.

In some embodiments of the present invention, the amount of the carboxylic acid is from 0% to 0.1%, and preferably from 0% to 0.01% by weight based on the total weight of the cyanoacrylate composition.

### Accelerator

The cyanoacrylate composition of the present invention may further comprise at least one accelerator, such as those selected from calixarenes and oxacalixarenes, silacrowns, crown ethers, cyclodextrins, polyethyleneglycol di(meth)acrylates, ethoxylated hydric compounds and combinations thereof.

Of the calixarenes and oxacalixarenes, many are known, and are reported in the patent literature.

See e.g. U.S. Pat. Nos. 4,556,700, 4,622,414, 4,636,539, 4,695,615, 4,718,966, and 4,855,461, the disclosures of each of which are hereby expressly incorporated herein by reference. One particularly desirable calixarene is tetrabutyl tetra[2-ethoxy-2-oxoethoxy] calix-4-arene.

Of the silacrowns, again many are known, and are reported in the literature. Specific examples of silacrown compounds useful in the inventive compositions include dimethylsila-11-crown-4, dimethylsila-14-crown-5, and dimethylsila-17-crown-6.

See e.g. U.S. Pat. No. 4,906.317 (Liu), the disclosure of which is hereby expressly incorporated herein by reference.

A host of crown ethers are known. For instance, any one or more of 15-crown-5, 18-crown-6, dibenzo-18-crown-6, benzo-15-crown-5-dibenzo-24-crown-8, dibenzo-30-crown-10, tribenzo-18-crown-6, asym-dibenzo-22-crown-6, dibenzo-14-crown-4, dicyclohexyl-18-crown-6, dicyclohexyl-24-crown-8, cyclohexyl-12-crown-4, 1,2-decalyl-15-crown-5, 1,2-naphtho-15-crown-5, 3,4,5-naphtyl-16-crown-5, 1.2-methyl-benzo-18-crown-6, 1.2-methylbenzo-5,6-methylbenzo-18-crown-6, 1,24-butyl-18-crown-6, 1,2-vinylbenzo-15-crown-5, 1,2-vinylbenzo-18-crown-6, 1,2-t-butyl-cyclohexyl-18-crown-6, asym-dibenzo-22-crown-6 and 1,2-benzo-1,4-benzo-5-oxygen-20-crown-7 may be used. See U.S. Pat. No. 4,837,260 (Sato), the disclosure of which is hereby expressly incorporated herein by reference.

Many cyclodextrins may be used in connection with the present invention. For instance, those described and claimed in U.S. Pat. No. 5,312,864 (Wenz), the disclosure of which is hereby expressly incorporated herein by reference.

Poly(ethylene glycol) di(meth)acrylates suitable for use herein include those within the following Structure:

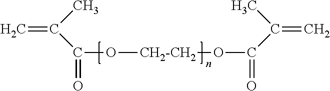

where n is greater than 3, such as within the range of 3 to 12, with n being 9 as particularly desirable. More specific examples include PEG 200 DMA (where n is about 4), PEG 400 DMA (where n is about 9), PEG 600 DMA (where n is about 14), and PEG 800 DMA, (where n is about 19), where the number (e.g., 400) represents the average molecular weight of the glycol portion of the molecule, excluding the two methacrylate groups, expressed as grams/mole (i.e., 400 g/mol).

Of the ethoxylated hydric compounds (or ethoxylated fatty alcohols that may be employed), appropriate ones may be chosen from those within the following Structure:

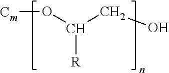

where Cₘ can be a linear or branched alkyl or alkenyl chain, m is an integer between 1 to 30, such as from 5 to 20, n is an integer between 2 to 30, such as from 5 to 15, and R may be H or alkyl, such as C1-6 alkyl.

In some embodiments of the present invention, the amount of the accelerator is from 0% to 5%, and preferably from 0% to 1% by weight based on the total weight of the cyanoacrylate composition.

In addition, the cyanoacrylate composition of the present invention may contain further one or more additives that are usually used in the cyanoacrylate composition, such as, plasticizers, thickening agents, fillers, inhibitors, thixotropy or gelling agents, dyes and combinations thereof.

In some embodiments of the present invention, the cyanoacrylate composition is preferably substantially free of alkyl cyanoacrylate which does not have an alkoxyl group, such as ethyl cyanoacrylate, butyl cyanoacrylate, octyl cyanoacrylate, 2-methylbutyl cyanoacrylate, and isoamyl cyanoacrylate. The alkyl cyanoacrylate which does not have an alkoxyl group is either not fully low odor or will cause blooming of the cyanoacrylate composition after cured. Further, the preparation of the cyanoacrylate composition of the present invention is also simplified if an alkyl cyanoacrylate which does not have an alkoxyl group is not used because less components are needed in the composition.

In a preferred embodiment, the cyanoacrylate composition comprises:

a) at least one rubber toughening compound;

b) at least one β-alkoxyalkyl cyanoacrylate represented by structure (I):

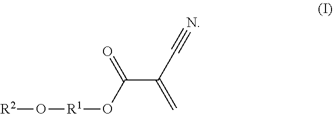

c) at least one acid stabilizer;

d) at least one accelerator; and

e) at least one carboxylic acid;

wherein

R¹ represents a C₁-C₈ optionally substituted divalent hydrocarbon group, preferably a C₁-C₄ optionally substituted divalent hydrocarbon group, and more preferably a C₂-C₃ optionally substituted divalent hydrocarbon group;

R² represents a C₂-C₂₀ optionally substituted univalent hydrocarbon group, preferably a C₂-C₈ optionally substituted univalent hydrocarbon group, and more preferably a C₂-C₄ optionally substituted univalent hydrocarbon group; and

the weight ratio between the β-alkyl cyanoacrylate of structural (I) and the rubber toughening compound is preferably from 100:0.5 to 100:50.

In some embodiments of the present invention, the cyanoacrylate composition of the present invention may be prepared by mixing all the components together at a temperature from 50 to 80° C. to dissolve the rubber toughening compound completely, and allowing the cyanoacrylate composition to be cooled to room temperature.

In some embodiments of the present invention, the cyanoacrylate composition may be applied to a substrate by bar coating, jetting or spraying, and allowed to be cured by moisture in the air at room temperature for a sufficient time to permit the composition to fixture, such as 1 to 3 days.

In some embodiment of the present invention, the cyanoacrylate composition may be used for bonding together two substrates by a method comprising the steps of:

a) applying a cyanoacrylate composition to at least one of the substrates; and

b) mating the substrates together for a sufficient time to permit the composition to fixture, such as 1 to 3 days.

The blooming of the cured product of cyanoacrylate composition may be measured by dropping several drops of cyanoacrylate composition onto a black substrate and allowing the cyanoacrylate composition to be fully cured. A high temperature and high humidity condition (e.g. 40° C./98% RH) may be applied to enhance and accelerate the blooming testing. The blooming of the cyanoacrylate composition is checked if a white ring or halo around the cured cyanoacrylate composition can be observed. The cyanoacrylate composition preferably does not show blooming after cured.

The solubility of the rubber toughening agent in the cyanoacrylate monomers may be measured by dissolving the rubber toughening agent in cyanoacrylate monomers. The mixture of the rubber toughening agent and cyanoacrylate monomers is mixed vigorously at a temperature from 50 to 80° C. until the rubber toughening agent is fully dissolved to obtain a clear solution. The solution is then cooled to room temperature. The solubility of the rubber toughening agent in the cyanoacrylate monomers is checked visually if the solution is still clear at room temperature. The rubber toughening agent is preferably completely dissolvable in the cyanoacrylate monomers.

The side impact of the cured product of the cyanoacrylate composition may be measured according to GM9751 General Motors Engineering Standards Side Impact Test, with a bonding area of 25.4 mm×25.4 mm. The cured product of the cyanoacrylate composition preferably has a side impact greater than or equal to 9 J, more preferably has a side impact greater than or equal to 11 J, and even more preferably has a side impact greater than or equal to 13 J in the case that the cyanoacrylate composition is allowed to be cured on grit blasted mild steel for 24 hours at room temperature. The cured product of the cyanoacrylate composition preferably has a side impact greater than or equal to 1.5 J, more preferably has a side impact greater than or equal to 6 J, and even more preferably has a side impact greater than or equal to 9 J in the case that the cyanoacrylate composition is allowed to be cured on aluminum plate for 24 hours at room temperature.

The T-peel strength of the cured product of the cyanoacrylate composition may be measured according to ASTM D1876/ISO 11339/DIN 53282, with a bonding area of 25.4 mm×228.6 mm. The cured product of the cyanoacrylate composition preferably has a T-peel strength greater than or equal to 0.5 N/mm, and more preferably has a T-peel strength greater than or equal to 4 N/mm in the case that the cyanoacrylate composition is allowed to be cured on grit blasted mild steel for 3 days at room temperature. The cured product of the cyanoacrylate composition preferably has a T-peel strength greater than or equal to 1.5 N/mm, and more preferably has a T-peel strength greater than or equal to 3 N/mm in the case that the cyanoacrylate composition is allowed to be cured on aluminum plate for 3 days at room temperature.

### EXAMPLES

The present invention will be further described and illustrated in detail with reference to the following examples. The examples are intended to assist one skilled in the art to better understand and practice the present invention, however, are not intended to restrict the scope of the present invention. All numbers in the examples are based on weight unless otherwise stated.

### Test Methods

### Blooming of Cured Cyanoacrylate Composition

The blooming of cured cyanoacrylate composition was measured by steps of:

a) dropping two drops of cyanoacrylate composition on a sheet of black plastic;

b) placing the sheet of black plastic horizontally in a humidity cabinet having a temperature of 40° C. and a relative humidity of 98%; and

c) checking if a white ring or halo appeared around the drops of cured cyanoacrylate composition after leaving the sheet of black plastic in the humidity cabinet for one hour.

If there was white ring or halo appeared around the drops of cured cyanoacrylate composition, the cyanoacrylate composition was determined to show blooming after cured.

### Solubility of Rubber Toughening Agent in Cyanoacrylate Monomers

The solubility of the rubber toughening agent in cyanoacrylate monomers was measured by steps of:

a) adding 10 grams of rubber toughening agent (VAMAC VCS 5500) to 100 grams of cyanoacrylate monomers in a mixing vessel;

b) mixing the mixture from step a) at 70° C. at a speed of 800 rpm for 3 to 5 hours until the rubber component is fully dissolved to obtain a clear solution;

c) transferring the solution into a glass vial and cooling the solution to room temperature; and

d) checking visually if the solution was still clear.

If the solution was clear, the rubber toughening agent was determined to be soluble in the cyanoacrylate monomers. If there were suspensions observed, the rubber toughening agent was determined to be insoluble in the cyanoacrylate monomers.

### Side Impact on Grit Blasted Mild Steel

The side impact of the cured product of the cyanoacrylate composition was measured according to GM9751 General Motors Engineering Standards Side Impact Test. The grit blasted mild steel were prepared by grit blasting on mild steel (available from Q-panel) with 80 mesh SiC powders. The dimension of grit blasted mild steel plate used for side impact testing was 25.4 mm×100 mm. Side impact specimens were prepared by applying ˜0.05 g cyanoacrylate composition on a bonding area of 25.4 mm×25.4 mm. The assembled specimens were cured at room temperature for 1 day.

### Side Impact on Aluminium Plate

The side impact of the cured product of the cyanoacrylate composition was measured according to GM9751 General Motors Engineering Standards Side Impact Test. The dimension of aluminum plate (available from Q-Panel Co. Inc.) used for side impact testing was 25.4 mm×100 mm. Side impact specimens were prepared by applying -0.05 g cyanoacrylate composition on a bonding area of 25.4 mm×25.4 mm. The assembled specimens were cured at room temperature for 1 day.

### T-Peel Strength on Mild Steel

The T-peel strength of the cured cyanoacrylate composition was measured according to ASTM D1876/ISO 11339/DIN 53282. The dimension of the mild steel plate (available from Q-Panel Co. Inc.) used for T-peel strength testing was 25.4 mm×304.8 mm. T-peel specimens were prepared by applying ˜0.5 g cyanoacrylate composition on a bonding area of 25.4 mm×228.6 mm. The assembled specimens were cured at room temperature for 3 days.

### T-Peel Strength on Aluminium Plate

The T-peel strength of the cured product of the cyanoacrylate composition was measured according to ASTM D1876/ISO 11339/DIN 53282. The dimension of the aluminum plate (available from Q-Panel Co. Inc.) used for T-peel strength testing was 25.4 mm×304.8 mm. T-peel specimens were prepared by applying ˜0.5 g cyanoacrylate composition on a bonding area of 25.4 mm×228.6 mm. The assembled specimens were cured at room temperature for 3 days.

### Example 1-7

The following materials were used in the Examples.

β-Ethoxyethyl cyanoacrylate (2-Ethoxyethyl 2-cyanoacrylate, available from Cartell Chemical);
Ethyl cyanoacrylate (Ethyl 2-cyanoacrylate, available from Sigma-Aldrich);
BF₃ (Boron trifluoride dihydrate, available from Sigma-Aldrich);
Rubber toughening compound (VAMAC VCS 5500, available from DuPont);
Citric acid (Citric acid anhydrous, available from Sigma-Aldrich);
β-Methoxyethyl cyanoacrylate (β-Methoxyethyl Cyanoacrylate, available from Afinitica); and
Crown ether (Dibenzo-18-crown-6, available from Ferak Berlin GmbH).

The cyanoacrylate compositions were formulated as Examples according to Table 1 by mixing all of the components at 70° C. at a speed of 800 rpm for 3 to 5 hours until all rubber toughening agent was fully dissolved, and allowed to be cooled to room temperature. Various tests described above were then performed on the cyanoacrylate compositions, and results were reported in Table 2.

TABLE 1
Cyanoacrylate composition

| | Weight Percentage | | | | | | |
|---|---|---|---|---|---|---|---|
| Components | Ex. 1 | Ex. 2 | Ex. 3 | Ex. 4 | Ex. 5 | Ex. 6 | Ex. 7 |
| β-ethoxyethyl | 98.788 | 95.788 | 89.788 | 79.788 | 69.788 | 0 | 0 |
| cyanoacrylate | | | | | | | |
| β-methoxyethyl | 0 | 0 | 0 | 0 | 0 | 0 | 89.788 |
| cyanoacrylate | | | | | | | |
| Ethyl cyanoacrylate | 0 | 0 | 0 | 0 | 0 | 89.788 | 0 |
| BF₃ | 0.002 | 0.002 | 0.002 | 0.002 | 0.002 | 0.002 | 0.002 |
| Vamac VCS 5500 | 1 | 4 | 10 | 20 | 30 | 10 | 10 |
| Citric acid | 0.01 | 0.01 | 0.01 | 0.01 | 0.01 | 0.01 | 0.01 |
| Crown ether | 0.2 | 0.2 | 0.2 | 0.2 | 0.2 | 0.2 | 0.2 |

Ex. 1 to 5 utilized β-ethoxyethyl cyanoacrylate as the monomers. The rubber toughening compound (Vamac VCS 5500) showed good solubility to the monomers in Ex. 1 to 5 which was comparable to the solubility of rubber toughening compound in Ex.6 when ethyl cyanoacrylate was used as the monomer. Cured products of the cyanoacrylate compositions in Ex.1 to 5 showed comparable T-peel strength to aluminum plate compared with Ex.6. Cured products in Ex.3 and 4 showed even improved side impact to grit blasted mild steel plate, and cured products in Ex.2 to 5 also showed better side impact to aluminum plate and T-peel strength to mild steel than Ex.6.

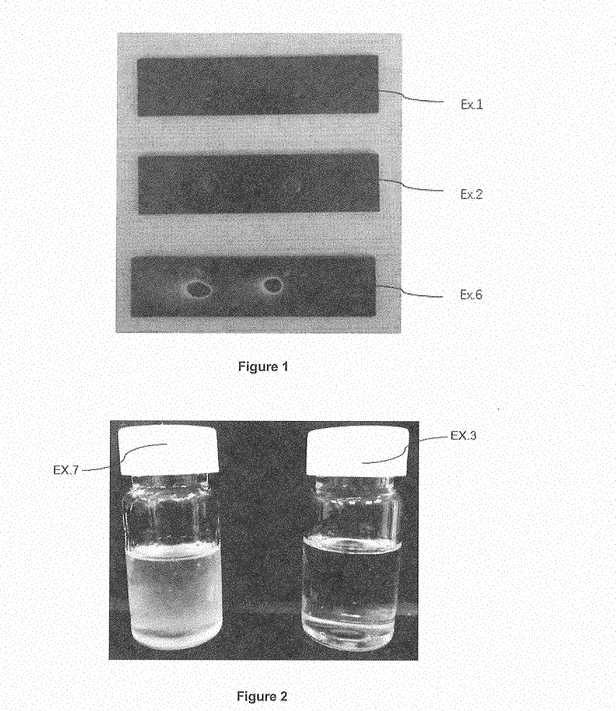

In addition, when ethyl cyanoacrylate was used as the monomer in Ex.6, the rubber toughening compound was well compatible with the monomer, but the cured product showed undesired blooming which could be seen from FIG. 1. When β-methoxyethyl cyanoacrylate was used as the monomer, the rubber toughening compound could be dissolved in the monomer at 70° C. during the mixing step. However, after the cyanoacrylate composition in Ex. 7 was cooled to room temperature, the β-methoxyethyl cyanoacrylate and the rubber toughening compound were not compatible anymore and suspensions were observed as shown in FIG. 2. The cyanoacrylate composition in Ex. 7 was not suitable to be used as adhesives, and therefore the side impact and T-peel strength test results were not available for Ex.7 in Table 2.

TABLE 2
Test results

| | Ex. 1 | Ex. 2 | Ex. 3 | Ex. 4 | Ex. 5 | Ex. 6 | Ex. 7 |
|---|---|---|---|---|---|---|---|
| Blooming | No | No | No | No | No | Yes | N/A |
| Solubility of rubber | Good | Good | Good | Good | Good | Good | Poor |
| toughening compound | | | | | | | |
| in different cyano- | | | | | | | |
| acrylate monomers | | | | | | | |
| Side Impact, grit | 11.1 | 11.7 | 13.3 | 13.6 | 9.0 | 10.8 | N/A |
| blasted mild steel | | | | | | | |
| plate (J) | | | | | | | |
| Side Impact, | 1.6 | 8.2 | 7.3 | 9.4 | 6.5 | 4.4 | N/A |
| aluminum plate (J) | | | | | | | |
| T-Peel Strength, | 0.7 | 4.6 | 4.0 | 4.7 | 4.4 | 2.5 | N/A |
| mild steel (N/mm) | | | | | | | |
| T-Peel Strength, | 2.3 | 1.8 | 3.4 | 3.2 | 3.0 | 2.7 | N/A |
| aluminum plate | | | | | | | |
| (N/mm) | | | | | | | |

What is claimed is:

1. A cyanoacrylate composition, comprising:
(a) at least one rubber toughening compound; and
(b) at least one β-alkoxyalkyl cyanoacrylate represented by structure (I): 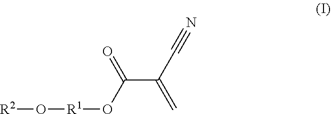
wherein
R¹ represents a C₁-C₈ optionally substituted with a divalent hydrocarbon group; and
R² represents a C₂-C₂₀ optionally substituted with a univalent hydrocarbon group.

2. The cyanoacrylate composition according to claim 1, the rubber toughening compound is selected from the group consisting of (a) reaction products of the combination of ethylene, methyl acrylate and monomers having carboxylic acid cure sites, (b) copolymer of ethylene and methyl acrylate, (c) vinylidene chloride-acrylonitrile copolymers, (d) vinyl chloride/vinyl acetate copolymer, (e) copolymers of polyethylene and polyvinyl acetate, and combinations thereof.

3. The cyanoacrylate composition according to claim 1, wherein the rubber toughening compound is a reaction product of the combination of ethylene, methyl acrylate and monomers having carboxylic acid cure sites, wherein the reaction product is substantially free of release agents, anti-oxidants, stearic acid and polyethylene glycol ether wax.

4. The cyanoacrylate composition according to claim 1, wherein the β-alkoxyalkyl cyanoacrylate is β-ethoxyethyl cyanoacrylate.

5. The cyanoacrylate composition according to claim 1, wherein the weight ratio between the β-alkoxyalkyl cyanoacrylate and the rubber toughening compound is from 100:0.5 to 100:50.

6. The cyanoacrylate composition according to claim 1, wherein the cyanoacrylate composition is substantially free of alkyl cyanoacrylate which does not have an alkoxyl group.

7. The cyanoacrylate composition according to claim 1, further comprising at least one acid stabilizer, and/or at least one accelerator, and/or at least one carboxylic acid.

8. The cyanoacrylate composition according to claim 1, comprising:
a) at least rubber toughening compound;
b) at least one β-alkoxyalkyl cyanoacrylate represented by structure (I): 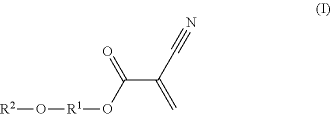
c) at least one acid stabilizer;
d) at least one accelerator; and
e) at least one carboxylic acid;
wherein
R¹ represents a C₁-C₈ optionally substituted with a divalent hydrocarbon group;
R² represents a C₂-C₂₀ optionally substituted with a univalent hydrocarbon group; and
the weight ratio between the β-alkyl cyanoacrylate of structure (I) and the rubber toughening compound is from 100:0.5 to 100:50.

9. A cured product of the cyanoacrylate composition according to claim 1.

10. An article bonded by the cyanoacrylate composition according to claim 1.

11. A process of preparing the cyanoacrylate composition according to claim 1, comprising steps of:
a) mixing all components together at a temperature from 50 to 80° C. to dissolve the rubber toughening compound completely to obtain a clear solution; and
b) cooling the solution from step a) to room temperature.

12. A method of bonding together two substrates, comprising the steps of:
a) applying a cyanoacrylate composition according to claim 1, to at least one of the substrates; and
b) mating together the substrates for a sufficient time to permit the composition to fixture.
